(19) United States
(12) Patent Application Publication
(10) Pub. No.: US 2023/0175459 A1
(43) Pub. Date: Jun. 8, 2023

(54) PLURALITY OF AIRBREATHING AND NON-AIRBREATHING ENGINES

(71) Applicant: LOGAN THOMAS REILLY, WINNETKA, CA (US)

(72) Inventor: LOGAN THOMAS REILLY, WINNETKA, CA (US)

(73) Assignee: LOGAN THOMAS REILLY, WINNETKA, CA (US)

(21) Appl. No.: 17/457,653

(22) Filed: Dec. 4, 2021

(51) Int. Cl. F02K 7/18; F02K 7/08; F02K 7/06; F02K 9/66

(52) U.S. Cl. CPC F02K 7/18; F02K 7/06; F02K 7/08; F02K 9/66; F05D 2240/35; F05D 2260/606

(57) ABSTRACT

Provided herein are various new or improved airbreathing and non-airbreathing engines. In another example, a new type of rotary engine is provided and is assembled into a single body from manufactured parts and comprising front and rear non-vented case plates, a detonation channel, a center case plate, a rotary gate valve spacer plate, front and rear bearing cover plates, front and rear centrifugal fan bearings and a non-vented centrifugal flywheel fan. The front non-vented case plate and the detonation channel includes an air intake port. The center case plate comprises an adjustable fuel aerosolizing combustor - detonator. The non-vented centrifugal flywheel fan comprises a plurality of rotary gate valves, a plurality of radial fan blades and a splined drive shaft. The rotary engine also comprises a plurality of case plate bolts, case plate post spacers, case plate nuts and bearing cover plate bolts.

### RELATED APPLICATIONS

Not Applicable

### STATEMENT REGARDING FEDERALLY SPONSORED

### RESEARCH OR DEVELOPMENT

Not Applicable

### REFERENCE TO A SEQUENCE LISTING, A TABLE, OR A COMPUTER PROGRAM LISTING COMPACT DISC APPENDIX

Not Applicable

### TECHNICAL BACKGROUND

Aircraft, Spacecraft, Ground and Marine propulsion systems can employ different engines and engine types that reflect the environments, the requirements and the types of payloads expected. The types of source engines or motors used for these vehicle propulsion systems include electric, nuclear and internal combustion engines. Internal combustion engines include airbreathing and non-airbreathing types. Airbreathing engines include reciprocating, rotary, and reaction engines. The reaction engines include gas turbine, ramjet, scramjet and detonation engines. Non-airbreathing types can also include reciprocating, rotary, rocket reaction and detonation engines.

The efficiency, range, environmental effects and cost to produce many of these types of engines presents a challenge to vehicle designers and manufacturers. Electric engines and their battery power sources are limited by their energy density which decreases range and increases weight. Nuclear engines are costly and prohibitive to only military vehicles. Internal combustion engines account for most of the remaining types of source engines in vehicles. These engines rely on non-renewable fossil fuels and are a major source of air pollution in the world.

Reciprocating engines are more fuel efficient than rotary or reaction engines but less reliable and require higher maintenance. Cams, valves, springs and piston rings are required to compress the fuel air mixture in the cylinder and this causes friction which requires lubrication. The force to compress the fuel air mixture reduces momentum of the piston along with the change in its direction. The connecting rod from the piston to the crankshaft requires lubrication and has little mechanical advantage to the stroke of the piston.

Gas turbine reaction engines are more reliable and require less maintenance than reciprocating engines but are less fuel efficient. Turbine blades and engine components are costly to produce. Compression of the fuel air mixture reduces compressor blade momentum and this pressure leaks at the stator. The hot combustion gas also leaks past the turbine power blades resulting in poor efficiency.

### Overview

Provided herein are various new or improved airbreathing and non-airbreathing engines.

In another example, a new type of rotary engine is provided and is assembled into a single body from manufactured parts and comprising front and rear non-vented case plates, a detonation channel, a center case plate, a rotary gate valve spacer plate, front and rear bearing cover plates, front and rear centrifugal fan bearings and a non-vented centrifugal flywheel fan. The front non-vented case plate and the detonation channel includes an air intake port. The center case plate comprises an adjustable fuel aerosolizing combustor - detonator. The non-vented centrifugal flywheel fan comprises a plurality of rotary gate valves, a plurality of radial fan blades and a splined drive shaft. The rotary engine also comprises a plurality of case plate bolts, case plate post spacers, case plate nuts and bearing cover plate bolts.

This overview is provided to introduce a selection of concepts that are described in the detailed description. It may be understood that this overview is not intended to identify key or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 24 is an orthographic front view of a Rotary Pulsed Detonation Engine Non-Vented Assembly with Rotary Gate Valves.

FIG. 25 is an orthographic front view of a Front Non-vented Case Plate for Rotary Gate Valves.

FIG. 26 is an orthographic front view of a Front Non-vented Case Plate for Gas Solenoid Valve or Rear Non-vented Case Plate.

FIG. 27 is an orthographic front hidden line view of a Detonation Channel for Rotary Gate Valves.

FIG. 28 is an orthographic front hidden line view of a Center Case Plate Assembly for Rotary Gate Valves.

FIG. 29 is an orthographic front view of a Rotary Gate Valve Spacer Plate.

FIG. 30 is an orthographic front view of a Bearing Cover Plate.

FIG. 31 is an orthographic front view of a Centrifugal Flywheel Fan Bearing.

FIG. 32 is an orthographic front hidden line view of a Centrifugal Flywheel Fan Non - Vented Assembly with Rotary Gate Valves.

FIG. 33 is an orthographic front view of a Rotary Pulsed Detonation Engine Non-Vented Assembly Section Diagram with Rotary Gate Valves.

FIG. 34 is an orthographic front view of a Rotary Pulsed Detonation Engine Vented Assembly with Rotary Gate Valves.

FIG. 35 is an orthographic front view of a Front Vented Case Plate.

FIG. 36 is an orthographic front view of a Rear Vented Case Plate.

FIG. 37 is an orthographic front hidden line view of a Centrifugal Flywheel Fan Vented Assembly with Rotary Gate Valves.

FIG. 38 is an orthographic front view of a Rotary Pulsed Detonation Engine Vented Assembly Section Diagram with Rotary Gate Valves.

FIG. 39 is an orthographic front hidden line view of a Rotary Pulsed Detonation Engine Vented Assembly with Rotary Gate Valves.

FIG. 40 Section View A - A

FIG. 41 Section View B - B

FIG. 42 Section View C - C

FIG. 43 Section View D - D

FIG. 44 Section View E - E

FIG. 45 Section View F - F

FIG. 46 Section View G - G

FIG. 47 is an orthographic front view of a Rotary Pulsed Detonation Engine Non-Vented Assembly with Gas Solenoid Valve Section Diagram.

FIG. 48 is an orthographic front view of a Rotary Pulsed Detonation Engine Vented Assembly with Gas Solenoid Valve Section Diagram.

FIG. 49 is an orthographic front hidden line view of a Detonation Channel for Gas Solenoid Valve.

FIG. 50 is an orthographic front hidden line view of a Center Case Plate Assembly for Gas Solenoid Valve.

FIG. 51 is an orthographic front hidden line view of a Centrifugal Flywheel Fan Non - Vented Assembly for Gas Solenoid Valve.

FIG. 52 is an orthographic front hidden line view of a Centrifugal Flywheel Fan Vented Assembly for Gas Solenoid Valve.

FIG. 53 is an orthographic front view of a Rotary Pulsed Detonation Engine Vented Assembly with Rotary Gate Valves and a Full - Bypass Rotary Ducted Fan Assembly.

FIG. 54 is an orthographic front view of an Aircraft with (2) Rotary Pulsed Detonation Engine Vented Assemblies with Rotary Gate Valves and with Full -Bypass Rotary Ducted Fan Assemblies.

FIG. 55 is an orthographic top view of a motor vehicle with a Rotary Pulsed Detonation Engine Non-Vented Assembly with Rotary Gate Valves located in the Front Engine Compartment.

### DETAILED DESCRIPTION

The air breathing and non-airbreathing engines described herein include a reaction type engine used to provide thrust for vehicular propulsion and a rotary mechanical motion type used to provide shaft horsepower for power generation, vehicular propulsion and a plurality of other functions. The Continuous Bypass Ram Detonation Engine and Rotary Pulsed Detonation Engine use a constant volume combustion-detonation process. This process is superior to the open cycle process used in gas turbines, rockets, ramjets and scram jets. A non-bypass center converging-diverging version of United States Air Force Research Laboratory Unsolicited Proposals No. UP 17-06, No. UP 17-07 and No. UP 18-4 has been demonstrated recently. This constant volume combustion-detonation process is also superior to the constant volume compression - expansion combustion process of the Otto, Atkinson or Miller cycle used in reciprocating or Wankel and other rotary engines.

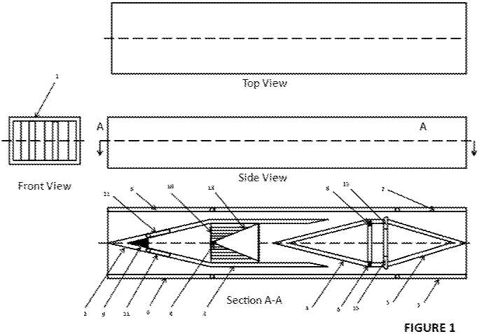

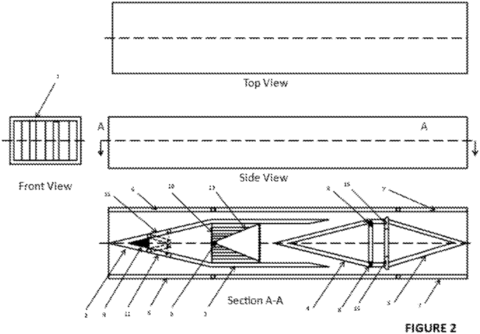

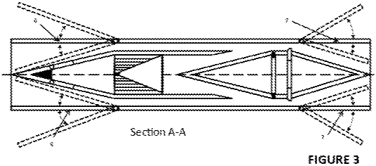

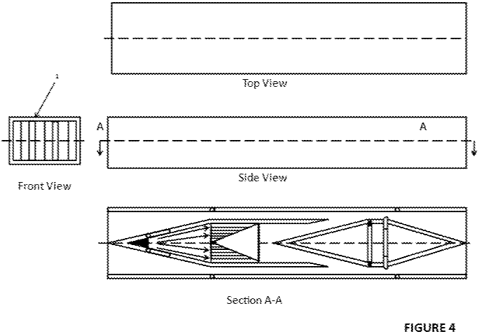

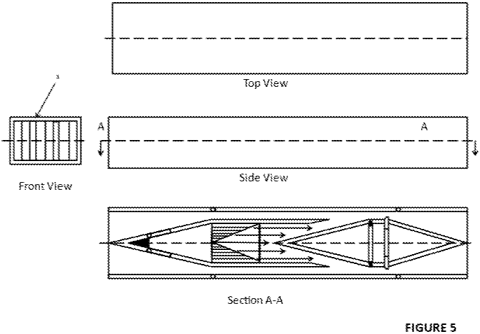

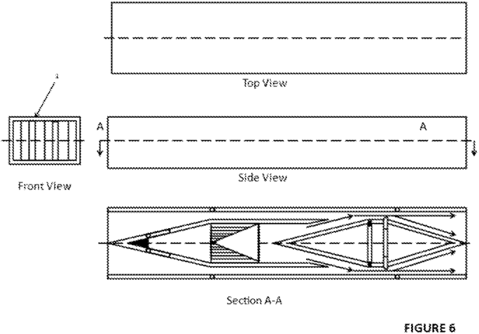

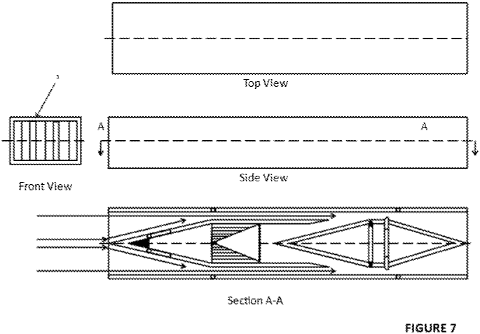

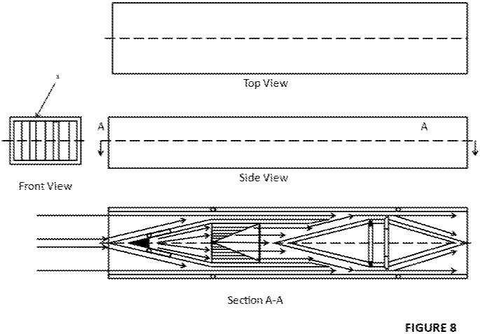

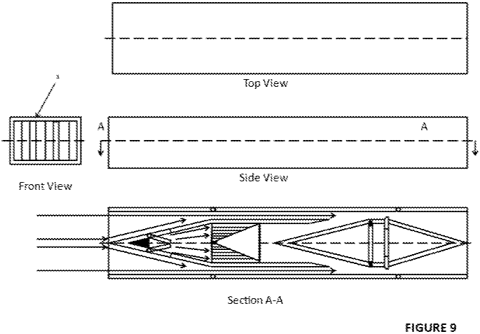

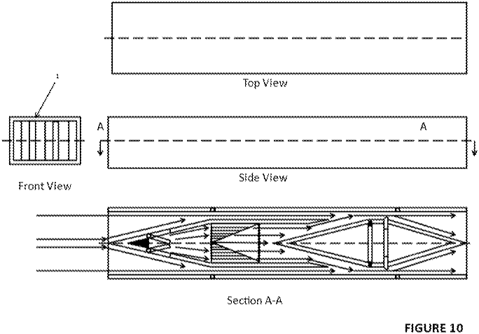

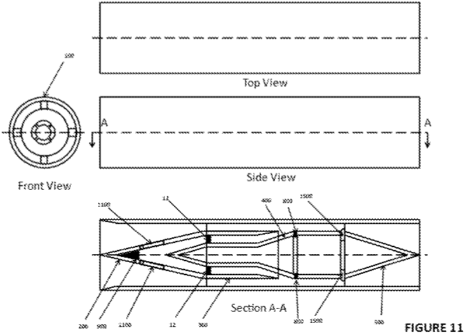

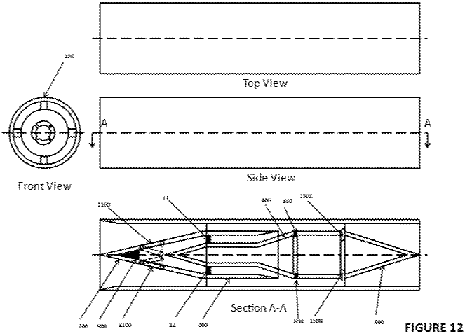

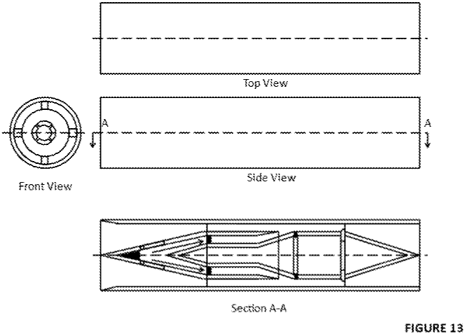

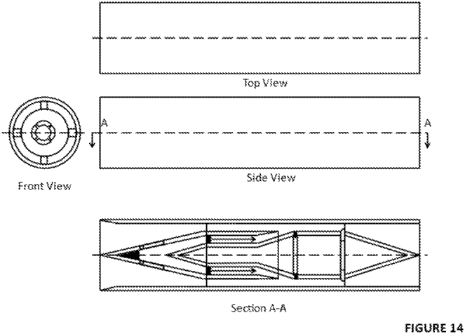

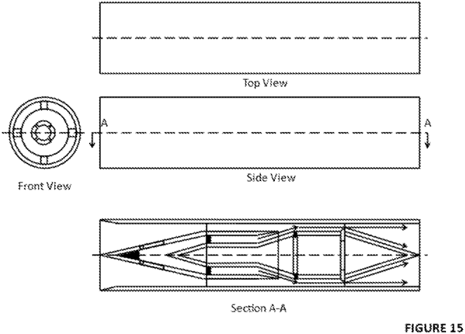

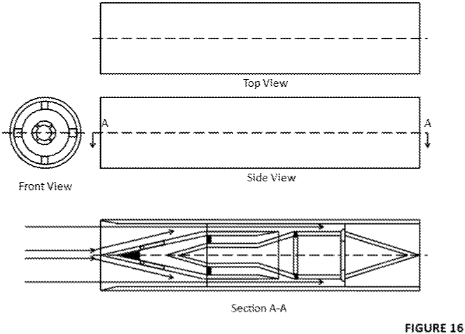

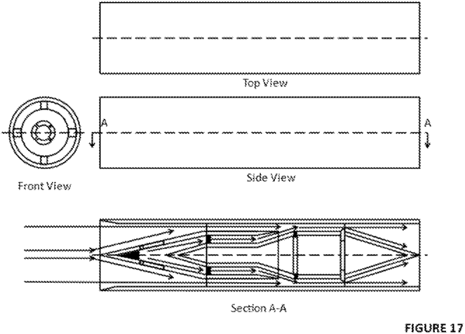

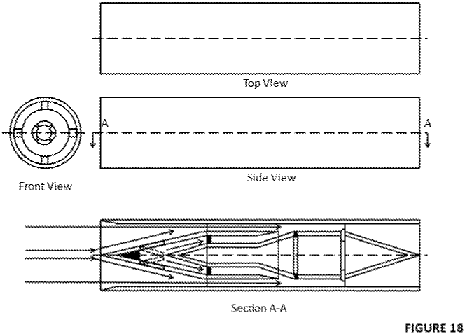

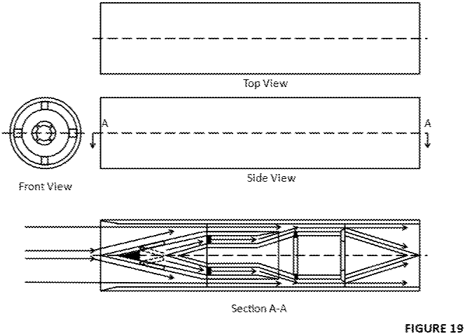

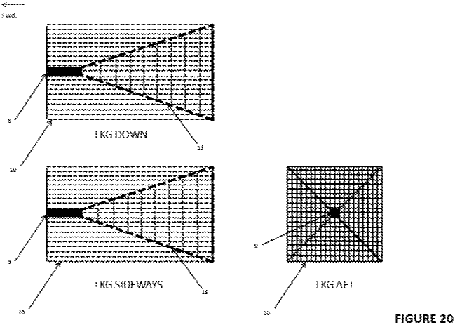

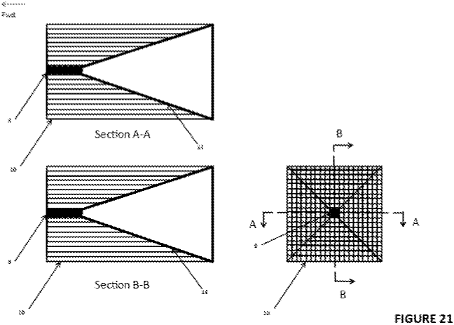

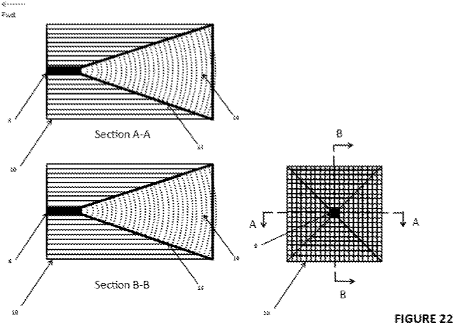

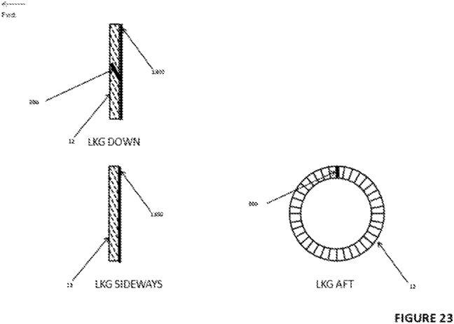

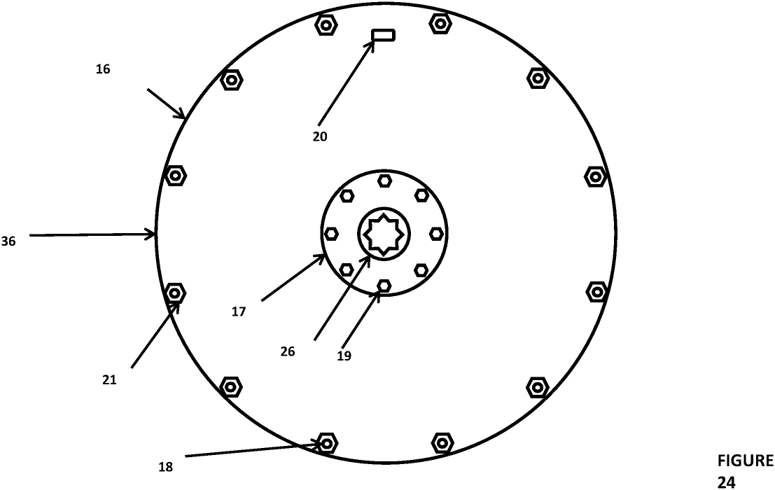

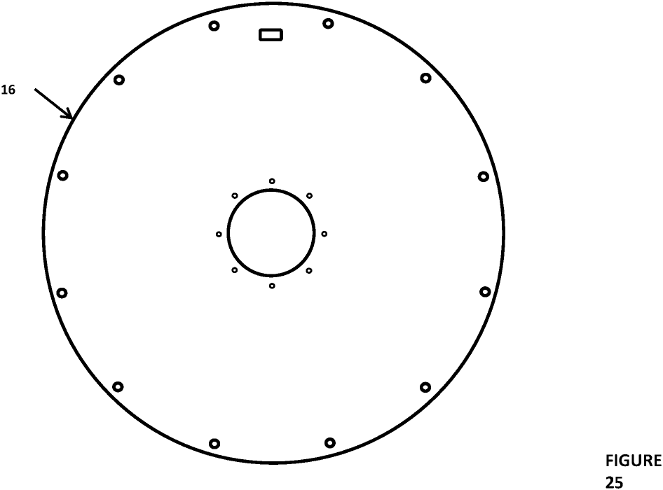

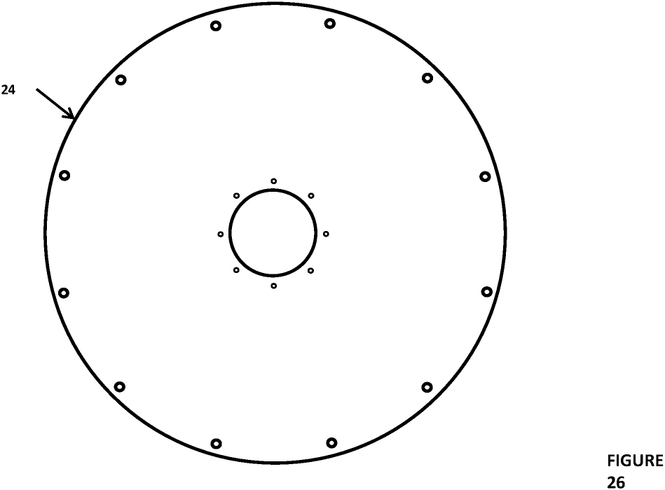

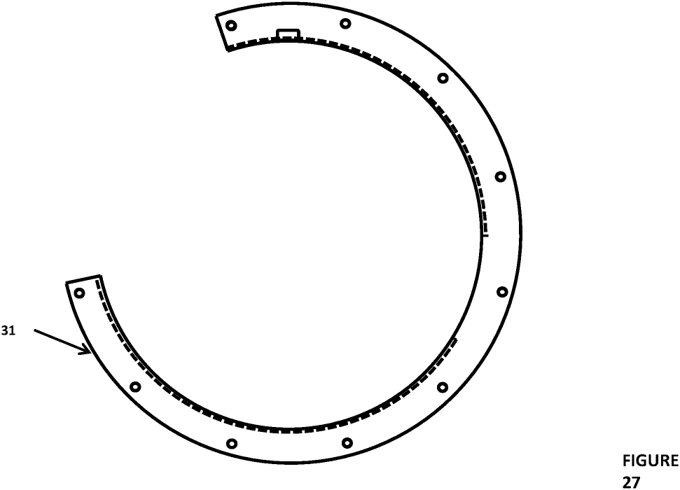

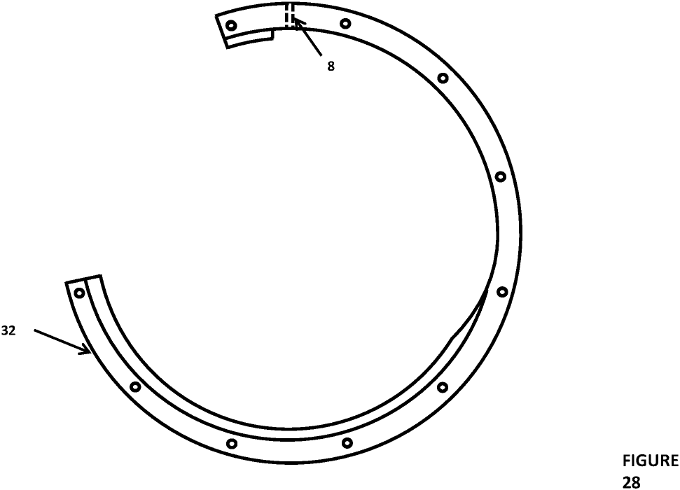

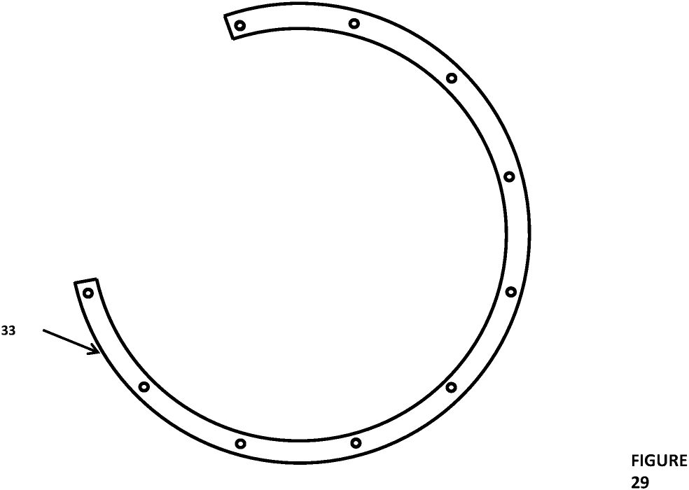

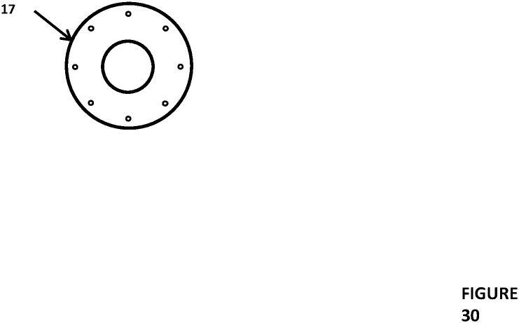

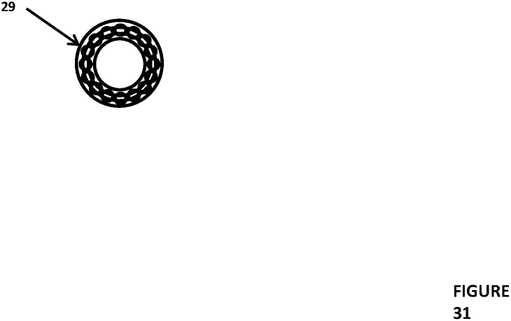

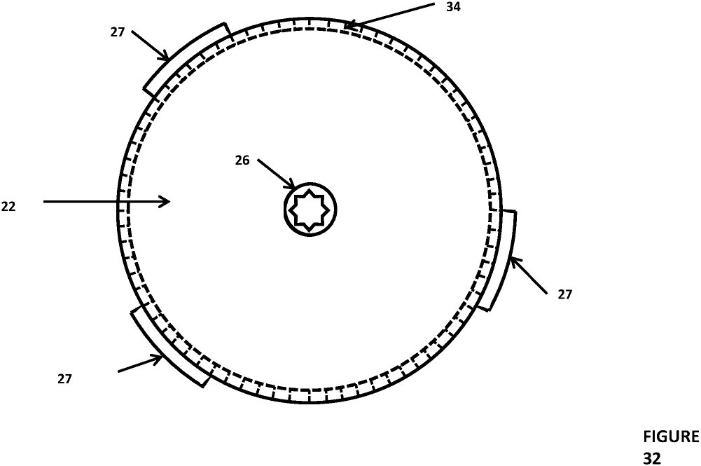

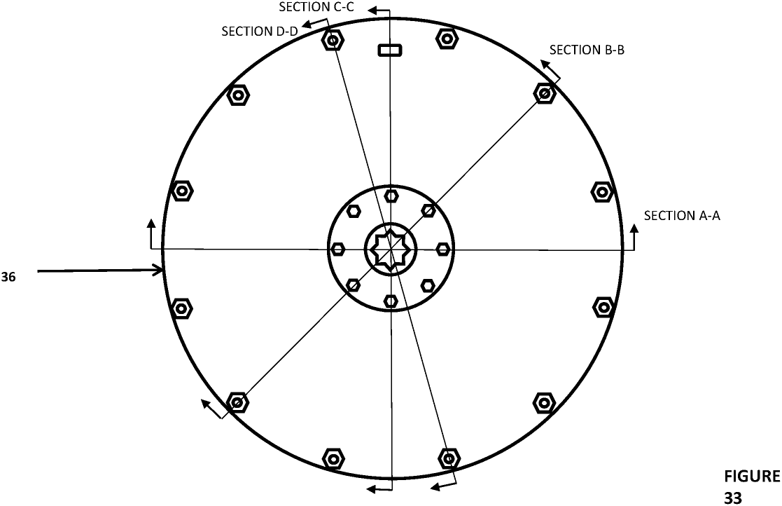

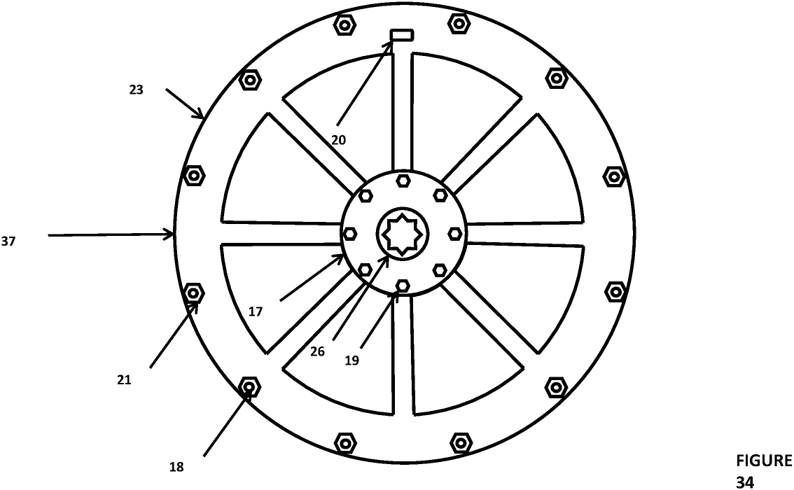

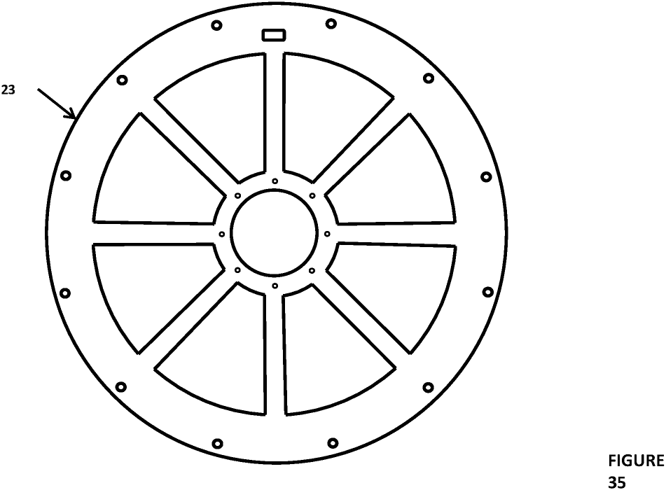

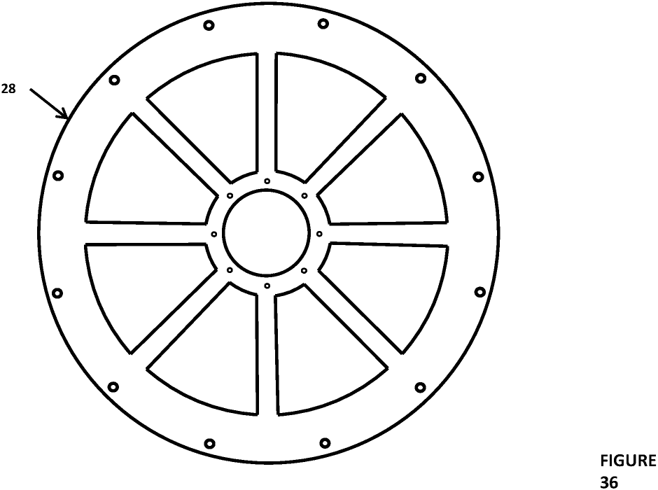

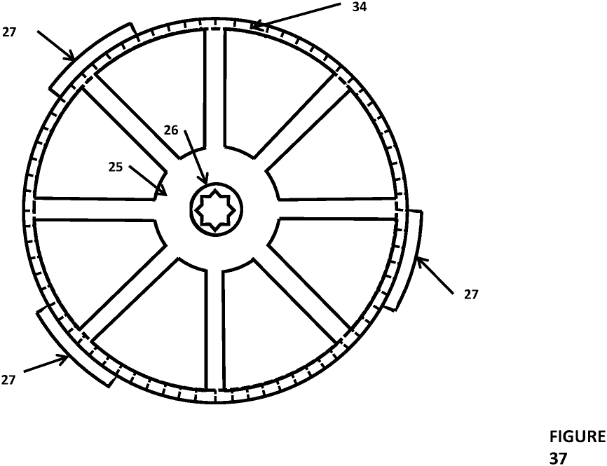

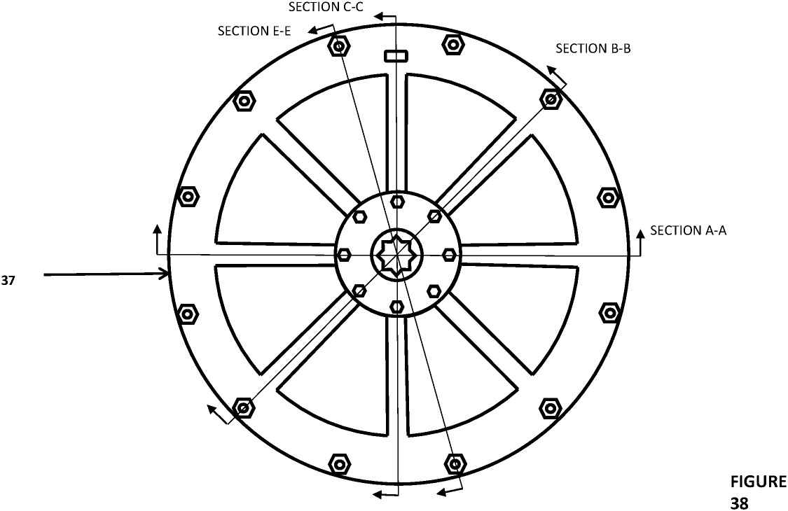

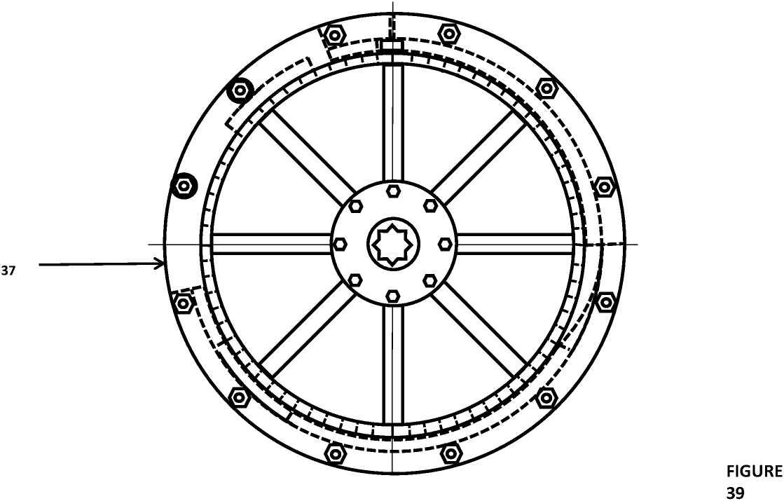

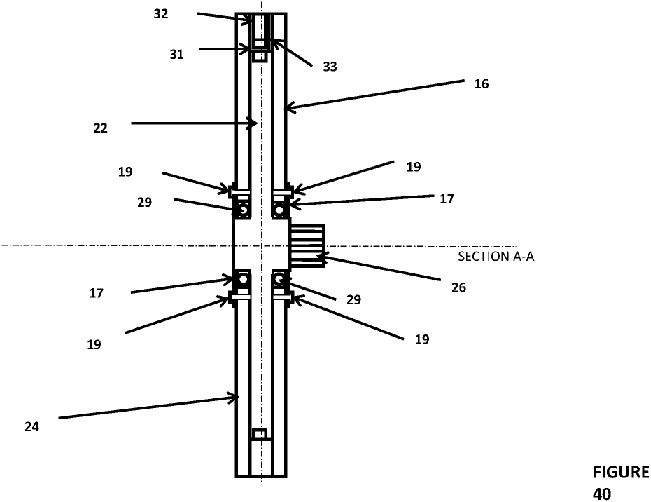

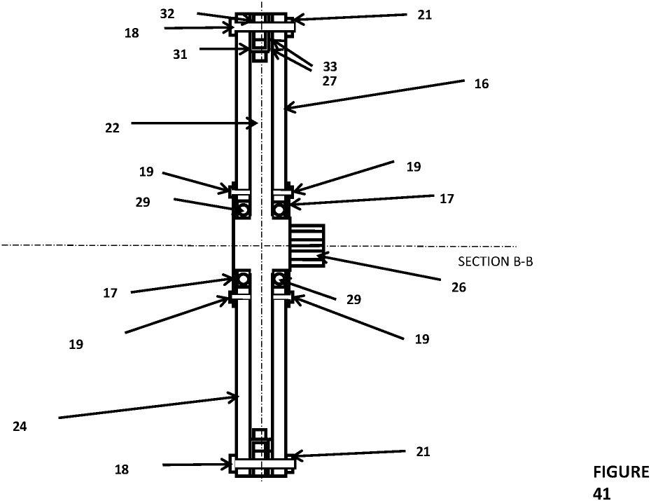

The Rotary Pulsed Detonation Engine shown in FIG. 24 and FIG. 34 initiates operation with an electric starter motor or hand crank that causes the centrifugal flywheel fan to rotate in a clockwise direction when looking at the front case plate. The centrifugal flywheel fan rotation causes outside air to be drawn in through the air intake port cutout in the front case plate through venturi vacuum action caused by movement of air and/or product between each radial fan blade 34.

The radial fan blades 34 on the flywheel act like a traditional centrifugal fan that draws outside air in through the air intake port 20 and through the detonation channel 31. As the air enters the detonation channel 31, fuel is added to the air by the adjustable fuel aerosolizing combustor detonator 8. This fuel -oxidizer mixture is drawn through the detonation channel 31 toward the cutout opening between the detonation channel and the outer radial fan blades 34 of the centrifugal flywheel fan.

The fuel - air mixture is then detonated from the timed ignition caused by the adjustable fuel aerosolizing combustor detonator 8. This detonation coincides with complete coverage and blockage of the air intake port cutout 20 in the detonation channel 31 and the front case plate. The detonation shock wave travels down the detonation channel 31 passage toward the centrifugal flywheel fan resulting in complete combustion of the fuel - oxidizer mixture and expulsion of the product into the passage between the outer centrifugal flywheel surface occupied by the radial fan blades 34 and the inner center case plate 32 surface. The product expulsion pressure causes the centrifugal flywheel fan to continue its clockwise rotation direction resulting in shaft horsepower at the splined drive shaft 26, continued venturi vacuum of outside air intake at the air intake port 20 and venturi vacuum purging/expulsion of the product in the detonation channel 31 into the centrifugal flywheel fan.

The product expulsion continues through the passage between the outer centrifugal flywheel surface occupied by the radial fan blades 34 and the inner center case plate 32 surface until the detonation channel 31 and the center case plate 32 terminate. At this location, the outer perimeter of the centrifugal flywheel fan is exposed to the outside air. The pressurized product that was contained between the walls, outer surface and radial fan blades 34 of the centrifugal flywheel fan and the inner surface of the center case plate 32, rapidly expands outward into the outside air between the exhaust case plate post spacers 35 causing exhaust product expulsion. Additional exhaust manifolds can be added to the engine at this location for desired noise suppression and turbo charged forced induction for intake air.

The engine cycle begins again after exhaust of the product. Most of the exhaust product is expelled from between the centrifugal flywheel fan radial blades 34. The remaining product and outside air are recirculated between the radial fan blades 34 in the continuous rotation of the centrifugal flywheel fan. This gas mixture between the radial blades 34 is important for the centrifugal flywheel fan to generate the venturi vacuum required to continuously draw outside air into the air intake port 20 and for purging/expulsion of the product from the detonation channel 31.

The rotation of the centrifugal flywheel fan and the position of the rotary gate valves 27 that are attached coincides with the timing of the ignition of the fuel –oxidizer mixture so that the air intake port 20 is covered and blocked during detonation of the fuel – oxidizer mixture to ensure product and pressure is prevented from traveling through the air intake port 20 and only travels through the detonation channel 31 in a clockwise direction toward the centrifugal flywheel fan. The air intake port 20 is then uncovered and unblocked after detonation of the fuel -oxidizer mixture as the rotary gate valve 27 rotates with the centrifugal flywheel fan in a clockwise direction allowing venturi vacuum air intake at the air intake port 20.

An electronic engine management system control unit is used for timing and volume of fuel delivery and the timing of the capacitor discharge ignition contained in the adjustable fuel – aerosolizing combustor – detonator 8. The adjustable fuel – aerosolizing combustor – detonator 8 combines adjustable fuel aerosolizing injectors 13 which delivers an aerosol of fuel into the gas stream of an oxidizer and a capacitor discharge spark plug ignition which ignites the fuel –oxidizer mixture.

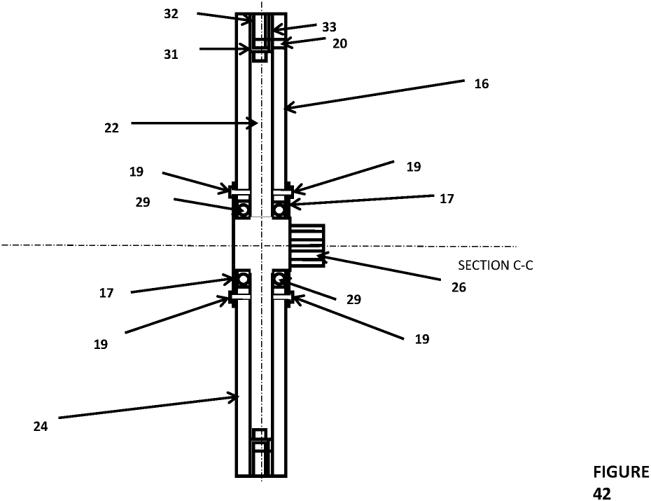

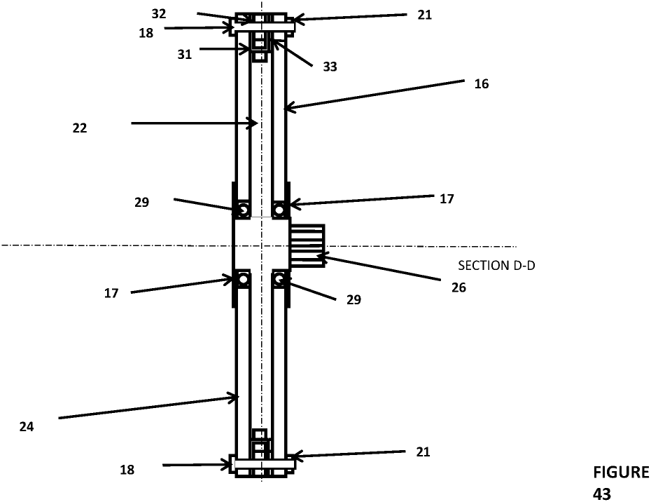

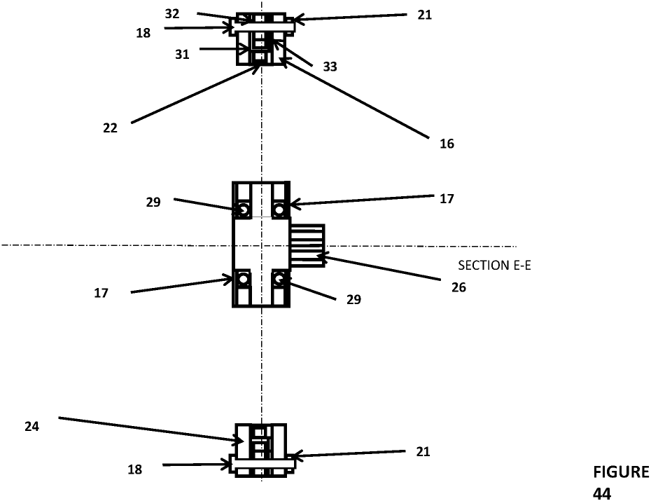

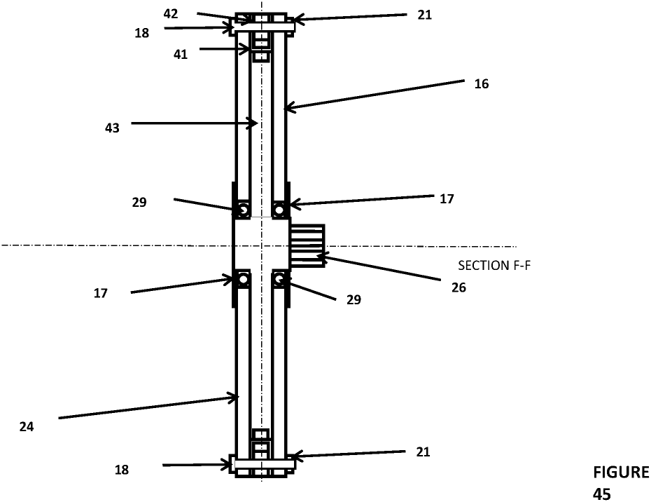

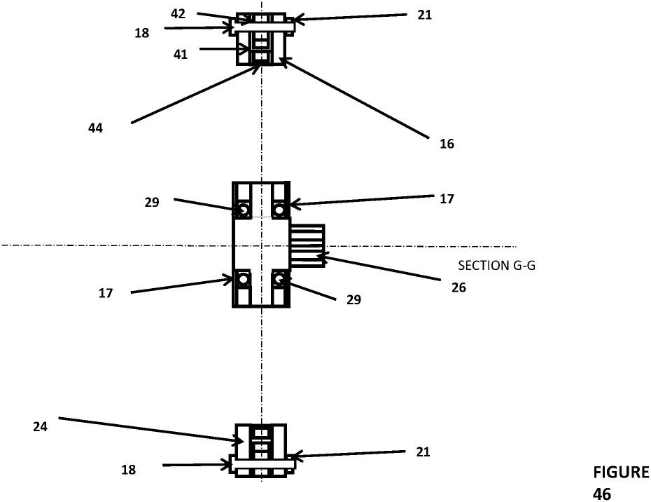

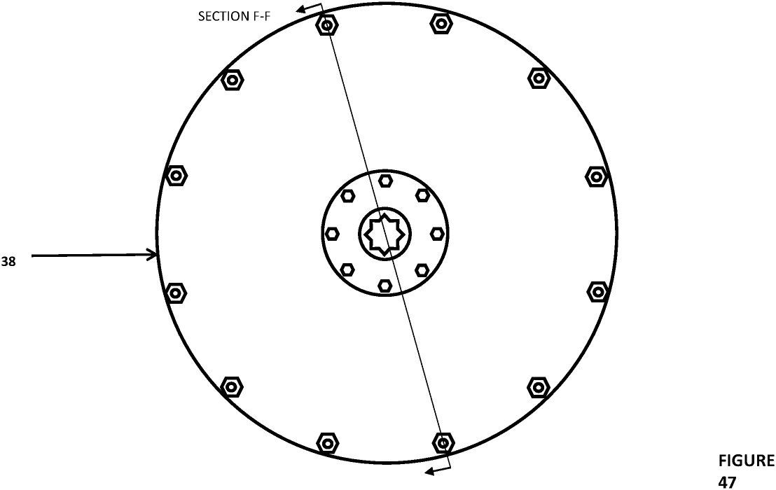

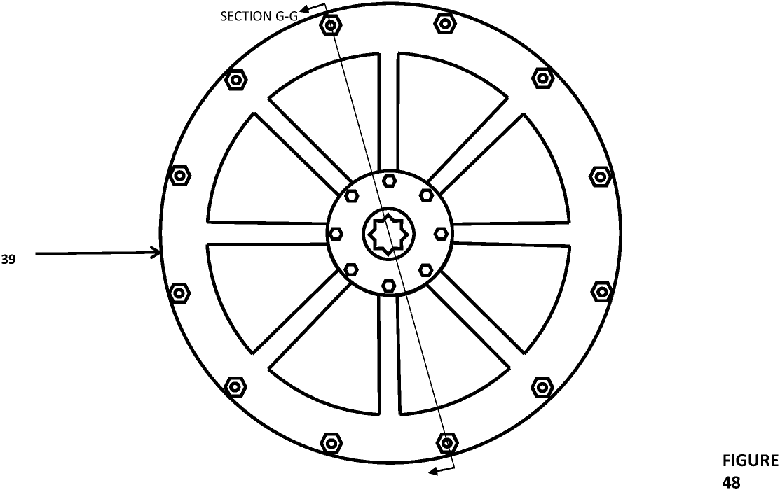

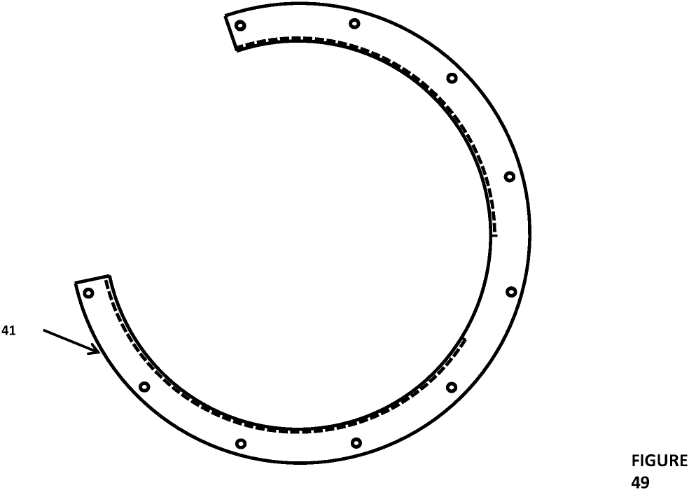

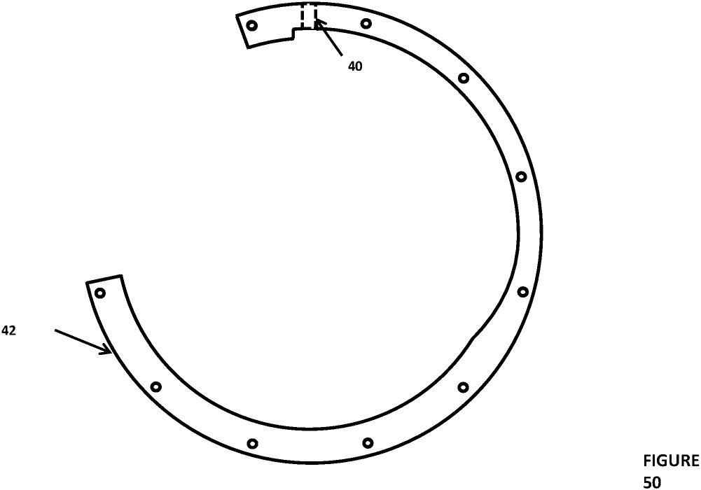

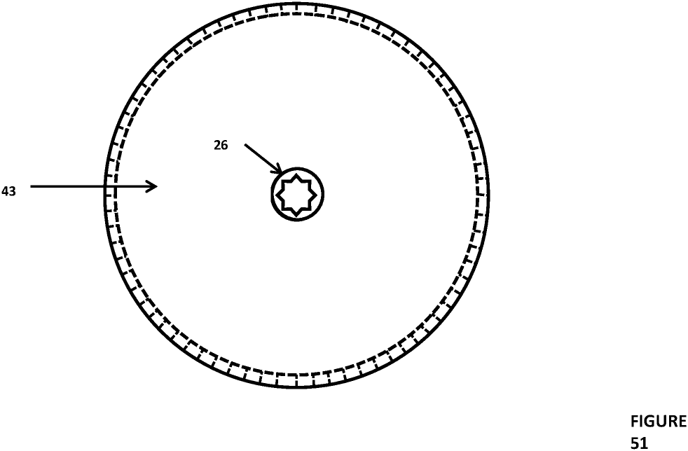

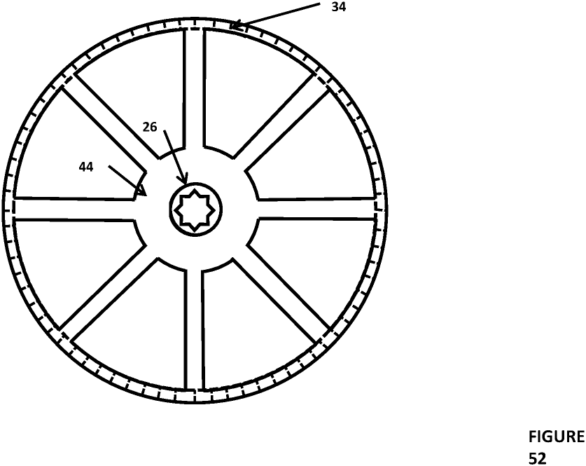

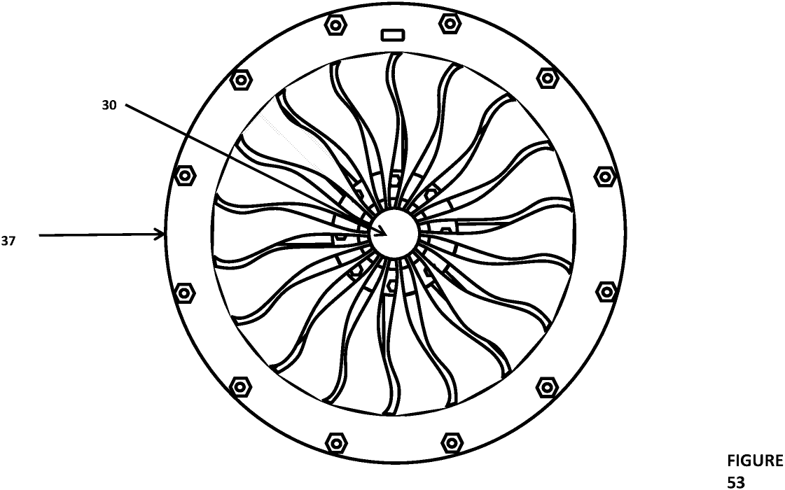

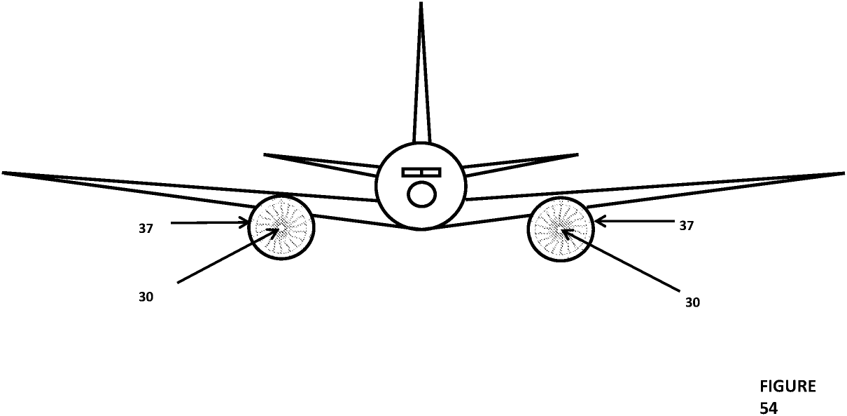

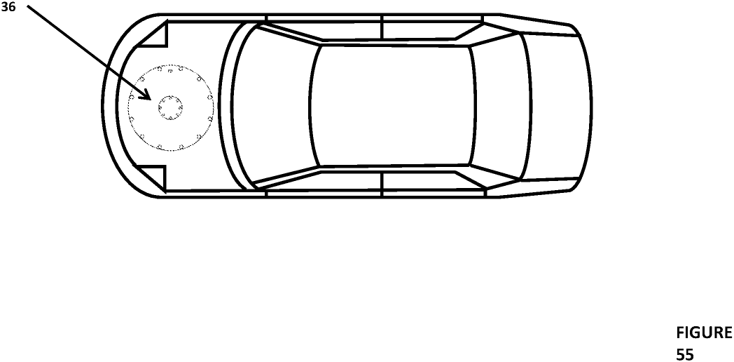

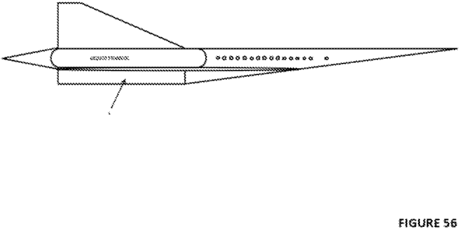

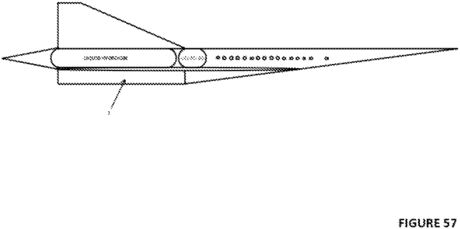

The Rotary Pulsed Detonation Engines shown in FIG. 47 and FIG. 48 initiates operation and maintains operation the same way as the engines shown in FIG. 24 and FIG. 34. The difference in the Rotary Pulsed Detonation Engines shown in FIG. 47 and FIG. 48 is that the cutout for air intake port 20 in the front case plate and in the detonation channel 31 are removed. The rotary gate valves 27 on the centrifugal flywheel fan and the cutout grove on the center case plate 32 are removed. The rotary gate valve spacer plate 33 is also removed from the assembly.

The adjustable fuel – aerosolizing combustor – detonator 8 located in the center case plate 32 is replaced with an adjustable fuel -aerosolizing combustor –detonator gas solenoid valve 40.

An electronic engine management system control unit is used for timing and volume of fuel delivery, the timing of the capacitor discharge ignition and the timing of the gas solenoid valve closure and opening which are all contained in the adjustable fuel – aerosolizing combustor – detonator gas solenoid valve 40. The adjustable fuel – aerosolizing combustor – detonator gas solenoid valve 40 combines adjustable fuel aerosolizing injectors 13 which delivers an aerosol of fuel into the gas stream of an oxidizer, the capacitor discharge spark plug ignition which ignites the fuel – oxidizer mixture and the gas solenoid valve that closes during ignition and opens after detonation.

The adjustable fuel – aerosolizing combustor – detonator gas solenoid valve 40 has the same function as the adjustable fuel – aerosolizing combustor – detonator 8 except that it provides air intake from outside air into the detonation channel 41 passage and it includes a solenoid valve that closes when the capacitor discharge spark plug igniter ignites the fuel – oxidizer mixture in the detonation channel 41 passage.

The Rotary Pulsed Detonation Engine shown in FIG. 24, FIG. 34, FIG. 47 and FIG. 48 operate on a three detonation per revolution cycle. This is where the fuel -oxidizer mixture is detonated when the centrifugal flywheel fan reaches a rotational position at top dead center. Top dead center is where the adjustable fuel aerosolizing combustor detonator 8 or the adjustable fuel aerosolizing combustor detonator gas solenoid valve 40 are located. This rotational position occurs every 120 degrees the centrifugal flywheel fan rotates. The Rotary Pulsed Detonation Engine can operate on a two or more detonation per revolution cycle depending on the length of the power stroke desired.

Certain inventive aspects may be appreciated from the foregoing disclosure, of which the following are various examples.

### Example 3

A rotary engine, FIG. 24 is a Non-Vented Rotary Pulsed Detonation Engine. FIG. 24 is a single body assembly comprising front 16 and rear 24 non-vented case plates, a detonation channel 31, a center case plate 32, a rotary gate valve spacer plate 33, front and rear bearing cover plates 17, front and rear centrifugal fan bearings 29 and a non-vented centrifugal flywheel fan 22. The front non-vented case plate 16 and the detonation channel 31 includes an air intake port 20. The center case plate 32 comprises an adjustable fuel aerosolizing combustor -detonator 8. The non-vented centrifugal flywheel fan 22 comprises a plurality of rotary gate valves 27, a plurality of radial fan blades 34 and a splined drive shaft 26. The rotary engine also comprises a plurality of case plate bolts 18, case plate post spacers 35, case plate nuts 21 and bearing cover plate bolts 19.

### Example 4

A rotary engine, FIG. 34 is a Vented Rotary Pulsed Detonation Engine. FIG. 34 is a single body assembly comprising front 23 and rear 28 vented case plates, a detonation channel 31, a center case plate 32, a rotary gate valve spacer plate 33, front and rear bearing cover plates 17, front and rear centrifugal fan bearings 29 and a vented centrifugal flywheel fan 25. The front vented case plate 23 and the detonation channel 31 includes an air intake port 20. The center case plate 32 comprises an adjustable fuel aerosolizing combustor - detonator 8. The vented centrifugal flywheel fan 25 comprises a plurality of rotary gate valves 27, a plurality of radial fan blades 34 and a splined drive shaft 26. The rotary engine also comprises a plurality of case plate bolts 18, case plate post spacers 35, case plate nuts 21 and bearing cover plate bolts 19.

### Example 5

A rotary engine, FIG. 47 is a Non-Vented Rotary Pulsed Detonation Engine. FIG. 47 is a single body assembly comprising front and rear 24 non-vented case plates, a detonation channel 41, a center case plate 42, front and rear bearing cover plates 17, front and rear centrifugal fan bearings 29 and a non-vented centrifugal flywheel fan 43. The center case plate 42 comprises an adjustable fuel aerosolizing combustor - detonator gas solenoid valve 40. The non-vented centrifugal flywheel fan 43 comprises a plurality of radial fan blades 34 and a splined drive shaft 26. The rotary engine also comprises a plurality of case plate bolts 18, case plate post spacers 35, case plate nuts 21 and bearing cover plate bolts 19.

### Example 6

A rotary engine, FIG. 48 is a Vented Rotary Pulsed Detonation Engine. FIG. 48 is a single body assembly comprising front and rear 28 vented case plates, a detonation channel 41, a center case plate 42, front and rear bearing cover plates 17, front and rear centrifugal fan bearings 29 and a vented centrifugal flywheel fan 44. The center case plate 42 comprises an adjustable fuel aerosolizing combustor -detonator gas solenoid valve 40. The vented centrifugal flywheel fan 44 comprises a plurality of radial fan blades 34 and a splined drive shaft 26. The rotary engine also comprises a plurality of case plate bolts 18, case plate post spacers 35, case plate nuts 21 and bearing cover plate bolts 19.

What is claimed is:

13. A Rotary Pulsed Detonation Engine comprising: a front and rear case plate; a detonation channel; a center case plate; front and rear bearing cover plates; front and rear centrifugal fan bearings; a centrifugal flywheel fan; a plurality of case plate bolts; a plurality of case plate post spacers; a plurality of case plate nuts; a plurality of bearing cover plate bolts.

14. The Rotary Pulsed Detonation Engine of claim 13, comprising:
a front case plate comprising an air intake port cutout; and a detonation channel comprising an air intake port cutout.

15. The Rotary Pulsed Detonation Engine of claim 13, comprising:
a center case plate comprising an adjustable fuel aerosolizing combustor -detonator; and a rotary gate valve spacer plate.

16. The Rotary Pulsed Detonation Engine of claim 13, comprising:
a centrifugal flywheel fan comprising a plurality of rotary gate valves; and a
plurality of radial fan blades; and a splined drive shaft.

17. The Rotary Pulsed Detonation Engine of claim 13, comprising:
a center case plate comprising an adjustable fuel aerosolizing combustor -detonator gas solenoid valve.

18. The Rotary Pulsed Detonation Engine of claim 13, comprising:
a centrifugal flywheel fan comprising a plurality of radial fan blades; and a splined drive shaft.
